(19) United States
(12) Patent Application Publication
(10) Pub. No.: US 2021/0076560 A1
(43) Pub. Date: Mar. 18, 2021

(54) AN IMPROVED RAKE WITH FORWARD FACING TINES

(71) Applicant: Michael J. Hanrahan, Plymouth, MN (US)

(72) Inventor: Michael J. Hanrahan, Plymouth, MN (US)

(21) Appl. No.: 16/887,540

(22) Filed: May 29, 2020

Related U.S. Application Data
(60) Provisional application No. 62/901,336, filed on Sep. 17, 2019.

(51) Int. Cl. A01D 11/06; A01D 7/02; A01D 7/06

(52) U.S. Cl. CPC A01D 11/06; A01D 7/06; A01D 7/02

(57) ABSTRACT

An improved rake includes a rake head coupled to a bar attached to the rake head. The rake head includes a set of spaced apart tines having an end distal from the rake head and configured to scoop debris from the ground in response to force being applied to the rake head via the bar such that the tines sift through grass and leaves and other debris ride up over the tines.

### RELATED APPLICATION

This application claims priority to U.S. Provisional Application Ser. No. 61/901,336 (entitled AN IMPROVED RAKE WITH FORWARD FACING TINES, filed Sep. 17, 2019) which is incorporated herein by reference.

### BACKGROUND

Raking leaves can be a strenuous task, as it involves raking, pulling, bending and stooping to gather the leaves. The repetitive nature of the work renders it extremely labor intensive and time consuming. It can also result in substantial back injuries to the person performing the task.

In a conventional rake, the tines at the end are L shaped to grab and hold leaves. A person cleaning their yard usually pulls the leaves together with the help of the L-shaped tines in order to either form heaps of leaves or clear them towards a corner. However, this pulling of the leaves and debris is not only time consuming, it is also physically strenuous.

### BRIEF DESCRIPTION OF THE DRAWINGS

FIG. 1 is a front view of an improved rake according to an example embodiment.

FIG. 2 is a side view of the rake head according to an example embodiment.

FIG. 3 is a perspective view of a rake according to an example embodiment.

FIG. 4 is a schematic of the rake according to an example embodiment.

FIG. 5 is a perspective view of a rake according to an example embodiment.

FIGS. 6A and 6B show front and back views of an alternate embodiment.

FIG. 7 includes several perspective views of an example rake head back with attached wheels according to an example embodiment.

FIG. 8 is a series of views of repositioning a rake handle according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural and other changes may be made without departing from the scope of the present invention. The following description of example embodiments is, therefore, not to be taken in a limited sense, and the scope of the present invention is defined by the appended claims.

In various embodiments, a new rake is configured to be pushed forward with forward extending tines that are part of a rake head. Pushing the rake forward results in the gathering of leaves and other debris into an upper portion of the rake head. The debris can then be dumped into a pile or bag for disposal or pushed into large piles much like a snowplow.

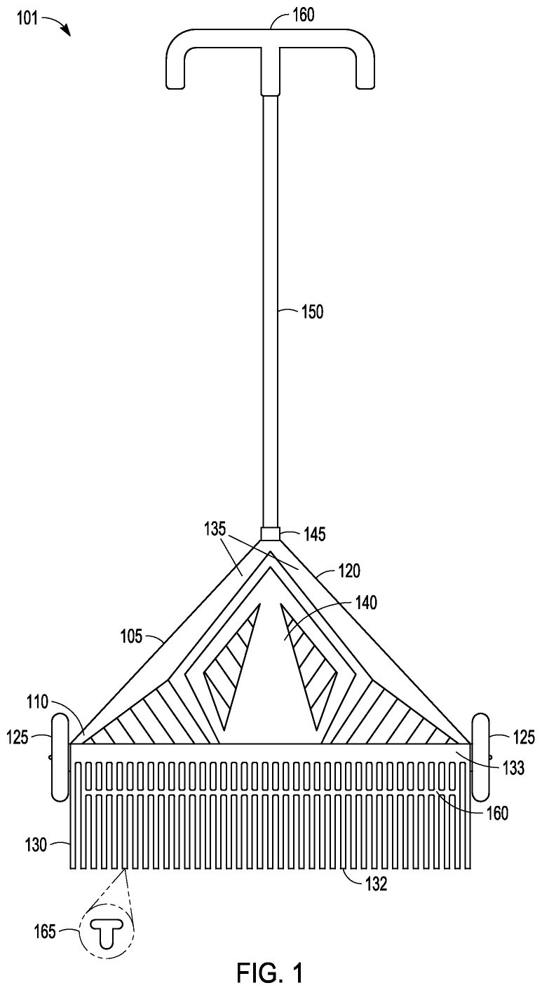

FIG. 1 is a front view of the rake 101 with a rake head 105. The rake head 105 may be triangular shape, as shown in the figure, but it is understood that other shapes may also be used. A lower portion 110 of the rake head 105 may be attached to at least one wheel 125 to reduce the effort needed to push large amounts of leaves or other debris. The lower portion 110, which may be wider than an upper portion 120 of the rake head 105, is attached to tines 130, at the end proximate to the ground during normal intended use of the rake 101. Guards 135 are placed on either side of the rake head 105 extending along the sides, from the upper portion 120 to the lower portion 110. The guards 135 along with the rake head 105 and the tines 130 form a receptacle 140 where debris, such as foliage or other material, can be amassed and form a barrier to allow the user to plow leaves like a bucket being pushed by a snow plow. The guards 135 may be shaped like a rectangle or a trapezoid, or any other shape configured to contain the debris that rolls over the tines 130.

The upper portion 120 of the rake head 105 is coupled to a bar 150 extending upwards from the base of the rake head 105 in a direction away from the direction that the tines extend from the rake head 105. The bar 150 may be coupled to the rake head 105 by the use of clamps 145, bolts, screws, welding, adhesive, and other means of securing the bar, with sufficient retentive force to maintain a reliable coupling under pressures associated with pushing amounts of material that accumulate on the rake head 105. In the example embodiments shown, the bar may comprise a handle 160, configured to be engaged by the hands of a user, on a distal end of the bar opposite the rake head 105. The handle 160 may be positioned perpendicular to the bar for ease of use while the user pushes the rake. The bar 150 and the handle 160 may be made of metal, such as steel or iron, or wood or plastic or similar rigid material. The handle 160 of the rake 101 may have a sleeve like layer covering sides of each side of the bar 150 for engagement with hands of the user of the rake 101. The sleeve like layer of the handle 160 may be made of an absorbent material like fabric or alternatively made of rubber to provide a better grip on the rake 101.

In one embodiment, a set of wheels 125 are attached to the lower end of the rake head 105, with the wheels coupled near opposite sides of the rake head 105, providing a stable support for the rake head 105 as it is being pushed in a forward direction to scoop debris. In another embodiment at least one wheel 125 may be attached at the back of the rake head 105, positioned in the middle to push the rake forward.

The tines 130 comprise a set of forward-facing individual tines extending from the rake head toward a distal end 132 of the tines. The tines are spaced apart to sift through the grass on the ground. The tines 130 also convey material, such as foliage and leaves, directly in front of the tines towards and into the receptacle 140 to form a barrier of leaves for subsequent leaves to be pushed forward like a snow plow. The tines 130 may have a convex curve with respect to the ground so that the distal end 132 of the tines do not dig into the ground while being pushed forward by the user. The forward facing individual tines 130 are supported by the rake head at a first end 133 and are curved at the other distal end 132, such that the distal ends 132 of the tines 130 are at or above the ground and configured to scoop debris from the ground up the spaced apart tines 130 onto the receptacle 140 in response to force being applied to the rake head 105 via the bar 150 to move the rake 101 along the ground. A support rail 160 may be coupled laterally across the set of tines to reinforce the tines and ensure that the alignment of the tines with respect to each other remains fairly constant. Additional support rails may be used in further embodiments. The cross section of the tines 130 may be ribbed or t-shaped as shown at 165 to be able to facilitate forward movement of the rake through the grass and foliage in the yard and provide structural support such that the tines maintain their shape under loads being pushed. The tines 130 may be made of metal or plastic or any other rigid material designed to maintain its structure while scooping up the leaves and debris.

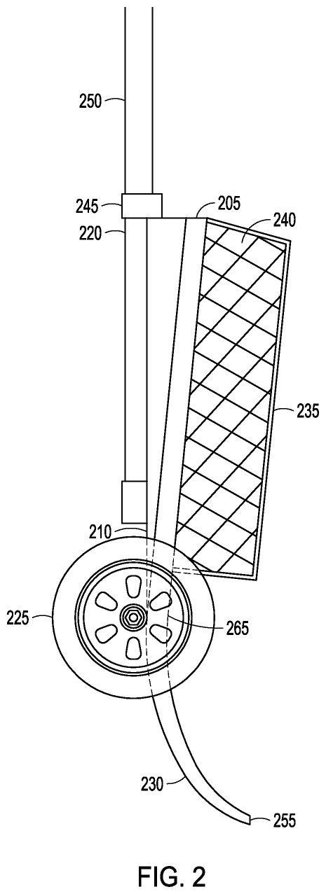

FIG. 2 is a side view of the improved rake illustrating a rake head 205, which supports a row of tines 230, and a guard 235 along sides of the rake head 205 extending from an upper portion 220 to a lower portion 210 of the rake head 205. The rake head 205 is attached to two wheels 225 at the lower portion 210 and a bar 250 extending upwards from the lower portion 210 of the rake head 205. The bar 250 may be attached to the rake head 205 using clamps 245 or other means of attachment. As shown in FIG. 2 the curved tines 230, have a distal end 255 configured to scoop up leaves and debris as the rake is being pushed forward in a direction away from the user. A radius of curvature of the tines 230 is located opposite a surface of which the tines are designed to pick up materials supported by the surface. The tines 230 extend from a first end 265 toward a distal end 255 with the radius of curvature selected such that the tines 230 contact the ground closer to the distal end 255 of tines. The distal end 255 may be curved such that the distal end 255 is slightly above the ground, yet not too far above the ground such that material supported above the ground slides under the tines. In one embodiment the distal ends of the tines may curve close to or proximate to the distal end so that the bottom ends of the tines 230 float at or slightly above the ground level. The convex curvature of the tines with respect to the ground during normal use enables the user to push the leaves and debris forward into heaps instead of pulling them, which saves energy and does not hurt the back or arms of the user.

The curved tines 230 sift through grass on the ground such that the leaves and debris pile up and are amassed in the receptacle 240 to form a barrier, which helps pile up the subsequent debris into a heap. The curvature of the tines 230 ensures an efficient sweep of the leaves and other material and prevents the tines 230 from digging into the ground while the leaves are being pushed into the rake head 205. The curvature of the tines 230 is in contrast to conventional rakes which have L-shaped tines, or angled tines which result in the rake gliding over the leaves without gathering them. The curved tines of rake 201 scoop the leaves and debris easily with minimal effort from the user. Note that the size of the receptacle may vary significantly in different versions of the rake. Further, the number of tines and length of the tines may also vary significantly depending on how much debris is feasible or convenient for various different types of user and use situations. For instance, larger, stronger users may desire larger receptacles.

The guards 235 may be supported on either side of the rake head 205, which may help prevent the scooped-up material from sliding off the rake. In a preferred embodiment the guards 235 along with the rake head and tines form the receptacle 240 holding a heap of leaves and debris as the rake 201 is pushed by the user. Each guard 235 is rectangular or trapezoid shaped to be able to contain the material that rolls in from the curved tines 230. The guards may be made of a metal like steel, or plastic, or a rigid material which is light weight, thus providing a structural element to the rake head 205 to hold the leaves and debris efficiently without increasing the load on the rake 201. The lightweight material will also enable the rake to move smoothly on the wheels as the user pushes the rake forward. The guard 235 may be expanded metal sheet or perforated or wire mesh or lattice to ensure increased structural strength.

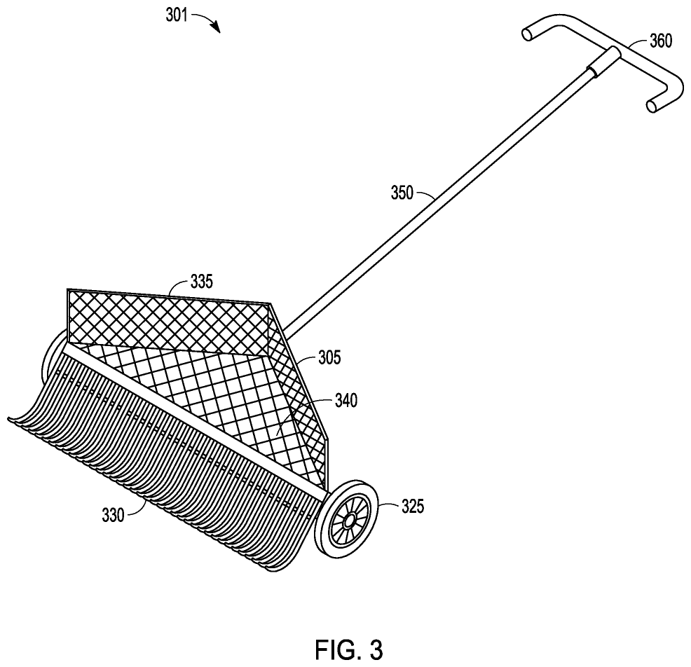

FIG. 3 shows a perspective view of the rake 301 with wheels 325 placed on either side of the rake head 305. Guards 335 along with tines 330 form the receptacle 340. The rake head 305 is attached to a bar 350, which is further attached to a handle 360 on the other end to provide the user support to push the rake. The leaves and foliage that rolls over the curved tines 330 get accumulated in the receptacle 340 as the user pushes the rake 301 and form a barrier to push more leaves and debris into a pile. The curvature of the tines 330 and the shape of the receptacle 340 help effectively collect the foliage on the ground as the rake 301 is pushed around in an open area. As the leaves and debris build up in the receptacle 340, they act as a barrier to other leaves on the ground, thereby aiding the user in pushing more leaves and debris forward into heaps.

Although the example in FIG. 3 illustrates a triangular receptacle 340 formed by the guards 335 and tines 330, it is understood that the receptacle 340 can be square or pentagonal or any other shape that is configured to receive the amassed leaves and debris that roll over the curved tines 330. The back of the receptacle 340 is made of a metal or plastic or similar rigid material. The guards 335 may be made from a metal or plastic or any other rigid material and may be meshed. The guards 335 as well as the back of the rake head 105 may be made using expanded or perforated metal or wire mesh to ensure structural strength of the rake head 105.

In another example embodiment, the guards 335 may be made out of a metal or plastic frame with a fabric such as burlap, covering to form the receptacle 340. The back of the receptacle 340 may also be made from a frame of triangular or any other shape, with a cloth covering to contain the leaves and debris.

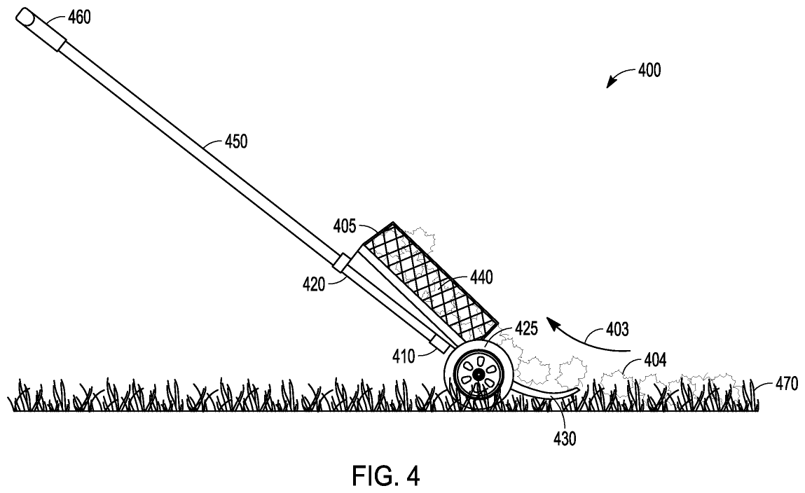

FIG. 4 shows the rake 400 when it is being used to clean an area in a garden or a yard. As shown in FIG. 4, the force applied to the rake 400 indicated by arrow 403 is in a direction away from the user such that leaves and debris 404 on the ground are scooped up into a receptacle 440. A person intending to clear an open area of leaves, foliage or debris on the ground can use the rake 400 with minimal effort, covering large areas at a time. As the user of the rake 400, holding the handle 460, pushes forward the rake 400, the rake head 405 acts as a plow pushing the leaves 404 forward. The leaves and debris 404 thus collect in front of the rake 400 move up over curved tines 430 towards the upper portion 420 of the rake head 405 as it is pushed by additional debris over the curved tines 430, into the receptacle 440. As the receptacle 440 is being filled with leaves, the receptacle 440 acts as a barrier to other leaves and debris 404 on the ground, and as the user pushes the rake 401 forward, the leaves and debris on the ground are also pushed easily into heaps. The length of the bar 450 may be adjustable to correspond to the height of an average user.

The wheels 425, attached to the lower portion 410 of the rake head 405, support the tines 430 proximate to the ground, close enough to operate to capture debris without creating significant friction. The wheels 425 roll along the ground in response to the force applied to the rake head 405 via the bar 450 to aid in a smooth movement of the tines 430 along the ground. While the tines 430 may contact the ground, the wheels 425 allow the user to vary the height of the tines by vertical movement of the handle 460 causing the tines 430 to pivot toward and away from the ground yet remain proximate the ground to capture debris. Downward vertical movement of the handle 460 can also be used to reduce the collection of debris as desired.

As illustrated in normal use in FIG. 4, the debris 404 is shown as being on top of and dispersed in grass indicated at 470. The tines 430 are shown as having distal ends that positioned above the ground, but within the grass in order to collect the debris 404. The distal ends of the tines may be slightly curved but are substantially parallel to the ground to facilitate picking up the debris 404 from the grass. In some example uses, the distal ends of the tines may be slightly tilted up from parallel to ensure the distal ends of the tines do not dig into the ground or become tangled in the grass 470. Movement of the handle can provide an additional adjustment of the angle of the distal end of the tines with respect to the ground as desired. The curvature of the tines may be varied. A more drastic curve may prevent debris from moving up the tines in to the receptacle.

Using the rake 401, long stretches on outdoor areas or yards can be raked effortlessly by pushing the leaves and debris to the center of the area, in long strips up to 30 to 40 yards or meters. Repeating this action throughout the area results in heaps of leaves which can easily be bagged for disposal. Alternatively, in rural areas where burning of the leaves in the yard is possible, the heaps of leaves from the long strips of the yard are convenient for burning. The rake may also be used to collect objects other than leaves and debris, such as acorns and twigs, which are heavier than leaves.

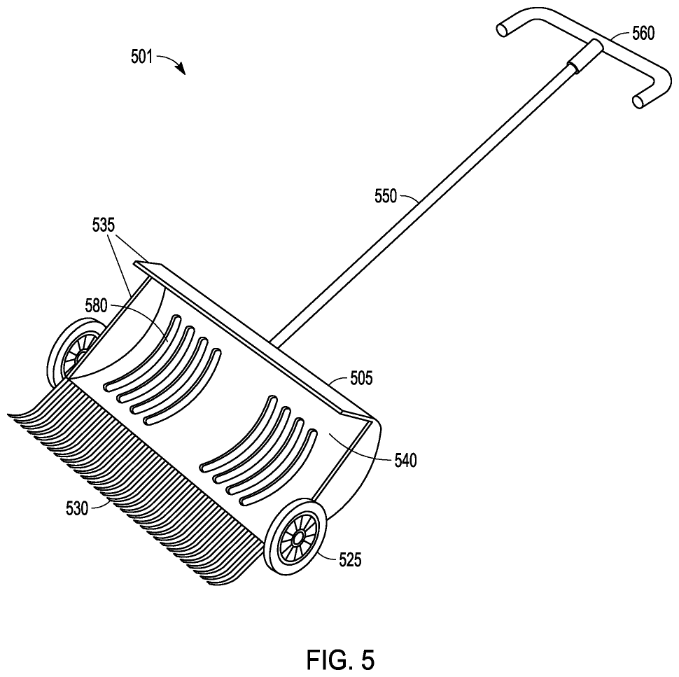

FIG. 5 shows a perspective view of another embodiment of a rake 501 with wheels 525 placed on either side of a rake head 505. Rake head 505 is attached to a bar 550, which is further attached to a handle 560 on the other end to provide the user support to push the rake. Guards 535 along with tines 530 form the receptacle 540, with the guards 535 forming barriers to the collected debris on three sides of the receptacle 540. The underside of receptacle 540 is curved in such a way that the leaves and debris rolling in from the curved tines 530 flows into the receptacle 540. The receptacle 540 may also contain vents 580, which allow for dirt and sand to be filtered out of the leaves and debris collected into the receptacle 540.

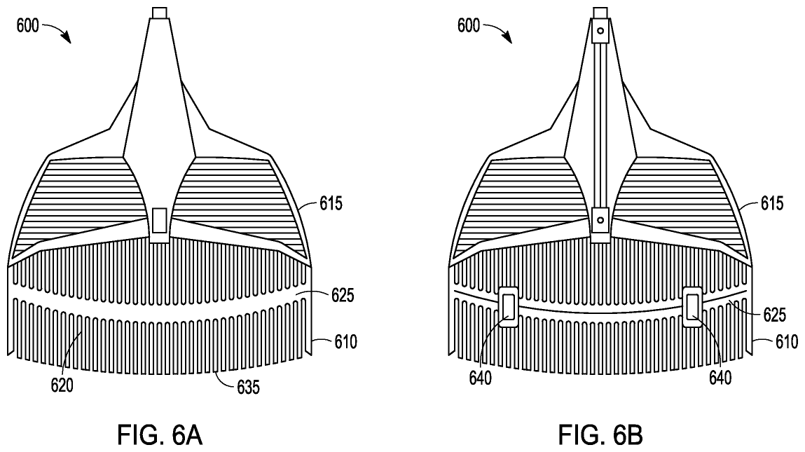

FIGS. 6A and 6B respectively show front and back views of an alternate rake head 600. A lower portion 610 of the rake head 600 is wider than an upper portion 615. The lower portion 610 includes tines 620 extending away from the rake head 600. The lower portion 610 of the rake head may include a support band or rail 625 positioned to support the tines between a proximate end 630 of the tines 620 attached to the upper portion 615 and a distal end 635 of the tines The support band or rail provides stability and strength to the tines. Wheels 640 are attached to the back of the rake head as seen in FIG. 6B. The wheels 625 may be casters attached via screws or by any other means to the back of the rake head 600. The wheel may be positioned at or near the support band or rail 625. Alternatively, skids may be used in place of wheels, or the tines 630 themselves may have an arcuate shape such that a portion of the tines proximate a distal end of the rake head may act as skids, holding tips of the tines a desired distance above the ground as the rake is used to gather leaves and other debris. In yet a further embodiment, a single wheel may be used. The single wheel may be wider than the wheels illustrated in the figures.

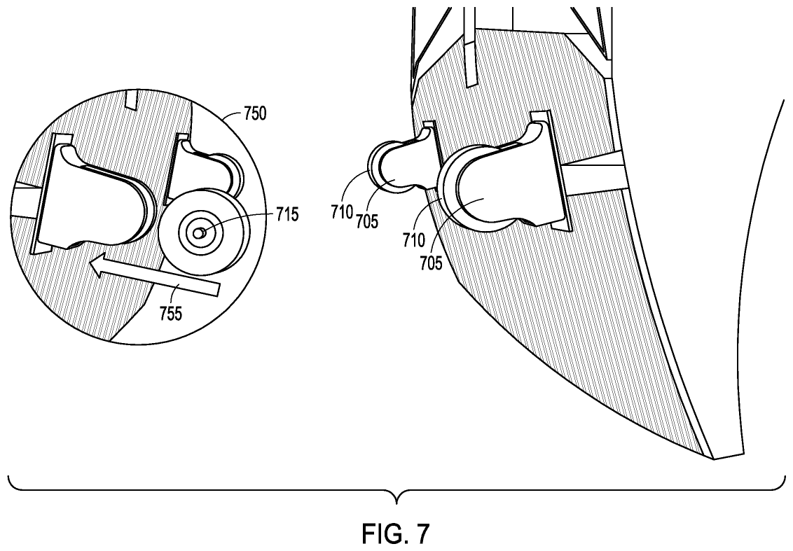

FIG. 7 includes several perspective views of an example rake head back generally at 700. In one embodiment, wheel housings 705 are injection molded as part of the rake head 700 with wheels 710 having axels 715 that are snap fit into corresponding holes or indentations in the wheel housings 705. The wheel housings 705 may simply comprise sides 720, 725 extending from a support 730 with holes in which the wheel axels 715 may simply be snapped into place as indicated generally at 750 and arrow 755. The wheels may be formed of rubber, plastic, or other suitable material.

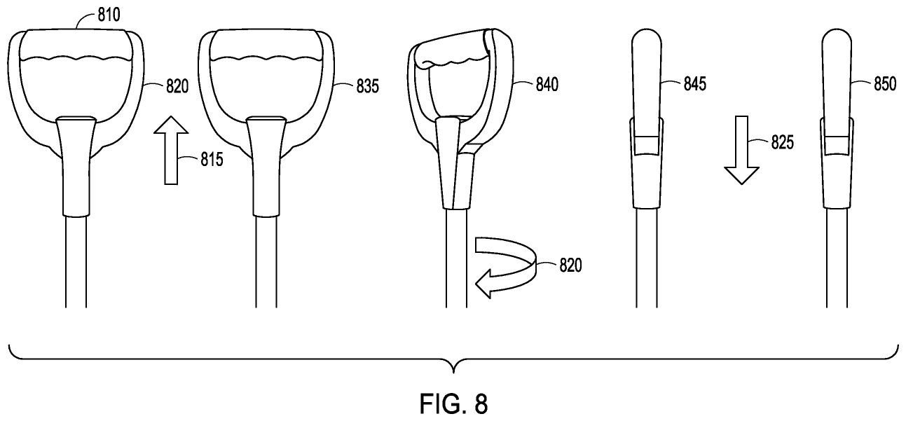

FIG. 8 is a series of views 800 of an alternative handle 810.

Handle 810 may be moved and locked into different positions. Movement of the handle for such moving and locking are shown by arrows 815, 820, and 825. Handle 810 is first shown in a position at 830 that is substantially parallel to the larger surface of a connected rake head. At 935, the handle 810 may be moved away from the rake head as indicated by arrow 815. The handle 810 may then be rotated as indicated by arrow 820 at 840 to a position substantially orthogonal to the rake head as indicated at 845. The handle is then pushed toward the rake head as indicated at arrow 825 to a locked position as indicated at 850. The handle may have protrusions that mate with multiple angularly positioned slots on a bar 860 coupling the handle 810 to the rake head, not shown.

### Examples

1. A device comprising:

a rake head;

a bar having a first end coupled to the rake head; and

a set of spaced apart curved tines supported by the rake head, the tines having an end distal from the rake head such that the distal end is at or above the ground and configured to scoop debris from the ground up the spaced apart tines onto a top of the rake head in response to force being applied toward the rake head via the bar to move the device along the ground.

2. The device of example 1 and further comprising guard plates attached to respective sides of the rake head.

3. The device of any of examples 1-2 and further comprising a handle coupled to a second end of the bar opposite the first end of the bar.

4. The device of any of examples 1-3 wherein the spaced apart tines are curved and coupled to the rake head to facilitate movement of the debris from the tines to the rake head.

5. The device of example 4 wherein the tines are curved with a radius of curvature on an opposite side of the tines from the ground as force is being applied to the rake head to move the tines across the ground.

6. The device of example 5 wherein the tines have a “T” shaped cross section.

7. The device of any of examples 1-6 and further comprising a pair of wheels supported by the rake head to support the tines proximate to the ground and roll along the ground in response to the force applied to the rake head via the bar.

8. The device of any of the examples 1-7 and further comprising a plurality of vents in the rake head.

9. A method comprising:

placing a user's hands on a handle of a device having a rake head, a bar having a first end coupled to the rake head, and a set of spaced apart curved tines supported by the rake head, the tines having an end distal from the rake head;

aligning the device at an angle such that the distal end of the tines are at or above the ground;

applying force in a direction away from the user such that debris on the ground that comes into contact with the distal end of the tines rolls over and is pushed into the top of the rake head.

10. The method of example 9 wherein the distal end of the tines is at or above the ground.

11. The method of example 10 wherein the tines are configured to scoop debris from the ground up the spaced apart tines onto a receptacle of the rake head in response to the force being applied to the rake head via the bar.

12. The method of any of examples 9-11 wherein the rake head moves on wheels coupled to a back side of the rake head.

13. The method of example 12 wherein the wheels are coupled to wheel wells integrated in to the rake head.

14. The method of any of examples 9-13 wherein the debris is sifted by the spaced apart tines.

15. A device comprising:

a receptacle;

a bar having a first end coupled to the receptacle; and

a set of spaced apart tines having a distal end positionable via the bar to collect debris from the ground and transfer the debris into the receptacle as the distal end of the tines moves toward the debris.

16. The device of example 15 wherein the tines are convexly curved with respect to the ground along at least a portion of a length of the tines.

17. The device of any of examples 15-16 wherein the tines include a proximal end opposite the distal end and wherein the proximal end is coupled to the receptacle.

18. The device of any of examples 15-17 wherein the bar has a second end opposite the first end having an adjustable handle.

19. The device of any of examples 15-19 wherein the tines and receptacle are formed as an integrated piece of injection molded plastic.

20. The device of example 19 wherein the integrated piece of injection molded plastic includes a pair of spaced apart wheel wells configured to accept axels of wheels to roll along the ground as the distal end of the tines moves toward the debris.

Although a few embodiments have been described in detail above, other modifications are possible. Other embodiments may be within the scope of the following claims.

1. A device comprising:
a rake head;
a bar having a first end coupled to the rake head; and
a set of spaced apart curved tines supported by the rake head, the tines having an end distal from the rake head such that the distal end is at or above the ground and configured to scoop debris from the ground up the spaced apart tines onto a top of the rake head in response to force being applied toward the rake head via the bar to move the device along the ground.

2. The device of claim 1 and further comprising guard plates attached to respective sides of the rake head.

3. The device of claim 1 and further comprising a handle coupled to a second end of the bar opposite the first end of the bar.

4. The device of claim 1 wherein the spaced apart tines are curved and coupled to the rake head to facilitate movement of the debris from the tines to the rake head as the tines move along the ground through grass in response to the force.

5. The device of claim 4 wherein the tines are curved with a radius of curvature on an opposite side of the tines from the ground as force is being applied to the rake head to move the tines across the ground.

6. The device of claim 5 wherein the tines have a “T” shaped cross section.

7. The device of claim 1 and further comprising a pair of wheels supported by the rake head to support the tines proximate to the ground and roll along the ground in response to the force applied to the rake head via the bar.

8. The device of claim 1 and further comprising a plurality of vents in the rake head.

9. A method comprising:
placing a user's hands on a handle of a device having a rake head, a bar having a first end coupled to the rake head, and a set of spaced apart curved tines supported by the rake head, the tines having an end distal from the rake head;
aligning the device at an angle such that the distal end of the tines are at or above the ground;
applying force in a direction away from the user such that debris on the ground that comes into contact with the distal end of the tines rolls over and is pushed into the top of the rake head.

10. The method of claim 9 wherein the distal end of the tines is at or above the ground.

11. The method of claim 10 wherein the tines are configured to scoop debris from the ground up the spaced apart tines onto a receptacle of the rake head in response to the force being applied to the rake head via the bar.

12. The method of claim 9 wherein the rake head moves on wheels coupled to a back side of the rake head.

13. The method of claim 12 wherein the wheels are coupled to wheel wells integrated in to the rake head.

14. The method of claim 9 wherein the debris is sifted by the spaced apart tines.

15. A device comprising:
a receptacle;
a bar having a first end coupled to the receptacle; and
a set of spaced apart tines having a distal end positionable via the bar to collect debris from the ground and transfer the debris into the receptacle as the distal end of the tines moves toward the debris.

16. The device of claim 15 wherein the tines are convexly curved with respect to the ground along at least a portion of a length of the tines.

17. The device of claim 15 wherein the tines include a proximal end opposite the distal end and wherein the proximal end is coupled to the receptacle.

18. The device of claim 15 wherein the bar has a second end opposite the first end having an adjustable handle.

19. The device of claim 15 wherein the tines and receptacle are formed as an integrated piece of injection molded plastic.

20. The device of claim 19 wherein the integrated piece of injection molded plastic includes a pair of spaced apart wheel wells configured to accept axels of wheels to roll along the ground as the distal end of the tines moves toward the debris.
